(19) United States
(12) Patent Application Publication
(10) Pub. No.: US 2017/0059314 A1
(43) Pub. Date: Mar. 2, 2017

(54) AUTO DEPTH LOCATOR

(71) Applicant: Vision Works IP Corporation, Sequim, WA (US)

(72) Inventor: Frtiz Braunberger, Sequim, WA (US)

(73) Assignee: Vision Works IP Corporation

(21) Appl. No.: 15/250,571

(22) Filed: Aug. 29, 2016

Related U.S. Application Data
(60) Provisional application No. 62/213,038, filed on Sep. 1, 2015.

(51) Int. Cl. G01B 21/18; A01K 91/06; G01B 5/02

(52) U.S. Cl. CPC G01B 21/18; G01B 5/02; A01K 91/06

(57) ABSTRACT

A system for and method of detecting and placing a line at a depth within a body of water comprises a reel for dispensing a quantity of line and an accelerometer for detecting a deviation of the dispensed line from a vertical axis. Based on the deviation of the dispensed line from the vertical axis and the amount of dispensed line a depth of the dispensed line within a moving body of water is able to be calculated. Additionally, based on the deviation of the dispensed line from the vertical axis and the desired depth of the line within a moving body of water, a necessary amount of line for the desired depth is able to be calculated.

### RELATED APPLICATION

This Patent claims priority under 35 U.S.C. 119(e) of the co-pending U.S. provisional patent application, Application No. 62/213,038, filed on Sep. 1, 2015, and entitled AUTO DEPTH LOCATOR,” and which is also hereby incorporated by reference in its entirety.

### FIELD OF THE INVENTION

The present invention relates generally to methods and systems for detecting a depth of a submerged line. More specifically, the present invention relates to a system and method of detecting and placing a line at a desired depth within a body of water.

### BACKGROUND OF THE INVENTION

Often it is desirable to know the depth of a line or object submerged within a body of water. When the water is static, or not moving, relative to the point of suspension of the line, a simple measurement of the line length will yield an accurate line depth. If the water is clear, an optical rangefinder is able to be employed that reflects off of an object secured to an end of the line to read the distance from the end of the line. If the water is static and not moving, the range would equal the depth. Additionally, more elaborate means are able to be employed, such as sonar. In some cases, such as when using a downrigger, a large mass or weight is employed at the end of the line to overcome the sweeping effect of a dynamic or moving water. The large mass increases the vertical component of the line relative to the sweeping, lateral component.

### SUMMARY OF THE INVENTION

A system for and method of detecting and placing a line at a depth within a body of water comprises a reel for dispensing a quantity of line and an accelerometer for detecting a deviation of the dispensed line from a vertical axis. Based on the deviation of the dispensed line from the vertical axis and the amount of dispensed line a depth of the dispensed line within a moving body of water is able to be calculated. Additionally, based on the deviation of the dispensed line from the vertical axis and the desired depth of the line within a moving body of water, a necessary amount of line for the desired depth is able to be calculated. The system and method is not dependent upon the water being static or optically transparent and does not requires more expensive or elaborate means.

In a first aspect, a system for determining a depth of a line submerged within a body of water comprises a reel for dispensing line, a mechanical sensor coupled to the reel for reading the amount of dispensed line, an accelerometer coupled to the line at which point the line becomes subject to gravity and configured for measuring a displacement of the line from a vertical axis, and a microprocessor that receives a signal from the mechanical sensor and the accelerometer and calculates a depth of the line based on the dispensed line and the deviation of the line from the vertical axis. In some embodiments, the accelerometer is located at a point of suspension of the line. In some embodiments, the line comprises a weight that causes the line to sink within the body of water. In further embodiments, the body of water is moving. In some embodiments, the depth of the line is outputted to an electronic screen. In some embodiments, the depth of the line is equal to the amount of dispensed line multiplied by the cosine of the angle of displacement.

In another aspect, a system for detecting an amount of line to dispense to a desired depth within a body of water comprises a fish finder for finding one or more fish at a depth within the body of water, an electronic reel for dispensing line, an accelerometer coupled to the line at which point the line becomes subject to gravity and configured for measuring a displacement of the line from a vertical axis, and a microprocessor that receives a signal from the fish finder and the accelerometer and calculates a necessary amount of line for the depth of the fish based on the depth of the one or more fish and the deviation of the line from the vertical axis. In some embodiments, the microprocessor sends a signal to the electronic reel to dispense the necessary amount of line for the depth of the one or more fish. In some embodiments, the accelerometer is located at a point of suspension of the line. In some embodiments, the line comprises a weight that causes the line to sink within the body of water. In further embodiments, the body of water is moving. In still further embodiments, the necessary amount of line for the depth of the one or more fish is outputted to an electronic screen. In some embodiments, the necessary amount of line for the depth of the one or more fish is equal to the depth of the fish divided by the cosine of the angle of displacement. In some embodiments, the microprocessor receives a signal from a trolling motor based on a trolling speed.

In a further aspect, a method of calculating a depth of submerged line comprises measuring a length of unwound line, sensing an angle of deviation of the unwound line from a vertical axis and based on the length of the unwound line and the deviation of the unwound line from the vertical axis calculating the depth of the line within a body of water. In some embodiments, an accelerometer is used to calculate the deviation of the unwound line from the vertical axis. In some embodiments, an incline meter is used to calculate the deviation of the unwound line from the vertical axis. In further embodiments, a gyroscope is used to calculate the deviation of the unwound line from the vertical axis. In some embodiments, the body of water is moving. In further embodiments, the depth of the line is outputted to an electronic screen. In some embodiments, the depth of the line is equal to the amount of dispensed line multiplied by the cosine of the angle of displacement.

In still a further aspect, a method of dispensing an amount of line to a desired depth comprises sensing a depth of one or more fish, sensing a deviation of dispensed line from a vertical axis, based on the depth of the one or more fish and the deviation of dispensed line from the vertical axis calculating a necessary amount of line for the depth of the fish and dispensing the necessary amount of line for the depth of the fish. In some embodiments, the body of water is moving. In some embodiments, the necessary amount of line for the depth of the one or more fish is outputted to an electronic screen. In further embodiments, the necessary amount of line for the depth of the one or more fish is equal to the depth of the fish divided by the cosine of the angle of displacement.

In another aspect, a system for determining a depth of a line submerged within a body of water comprises a mechanical sensor coupled to a reel for reading an amount of dispensed line, an accelerometer coupled to the line and configured for measuring a displacement of the line from a vertical axis and a microprocessor that receives a signal from the mechanical sensor and the accelerometer and calculates a depth of the line based on the dispensed line and the deviation of the line from the vertical axis.

In a further aspect, a method of calculating a depth of submerged line comprises sensing an angle of deviation of an unwound line from a vertical axis and based on a length of the unwound line and the deviation of the unwound line from the vertical axis calculating the depth of the line within a body of water.

### BRIEF DESCRIPTION OF THE DRAWINGS

FIGS. 1A and 1B illustrate a system for determining the depth of line submerged within a body of water in accordance with some embodiments.

FIGS. 2A and 2B illustrate a system for determining the depth of line submerged within a body of water in accordance with some embodiments.

FIG. 3 illustrates a method of determining the depth of line submerged within a body of water in accordance with some embodiments.

FIG. 4 a method of dispensing an amount of line to a desired depth in accordance with some embodiments.

### DETAILED DESCRIPTION

Embodiments of the invention are directed to a system for and method of detecting and placing a line at a depth within a body of water comprises a reel for dispensing a quantity of line and an accelerometer for detecting a deviation of the dispensed line from a vertical axis. Based on the deviation of the dispensed line from the vertical axis and the amount of dispensed line a depth of the dispensed line within a moving body of water is able to be calculated. Additionally, based on the deviation of the dispensed line from the vertical axis and the desired depth of the line within a moving body of water, a necessary amount of line for the desired depth is able to be calculated.

Reference will now be made in detail to implementations of system for and method of detecting and placing a line at a depth within a body of water as illustrated in the accompanying drawings. In the interest of clarity, not all of the routine features of the implementations described herein are shown and described. It will be appreciated that in the development of any such actual implementation, numerous implementation-specific decisions can be made in order to achieve the developer's specific goals, such as compliance with application and business related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

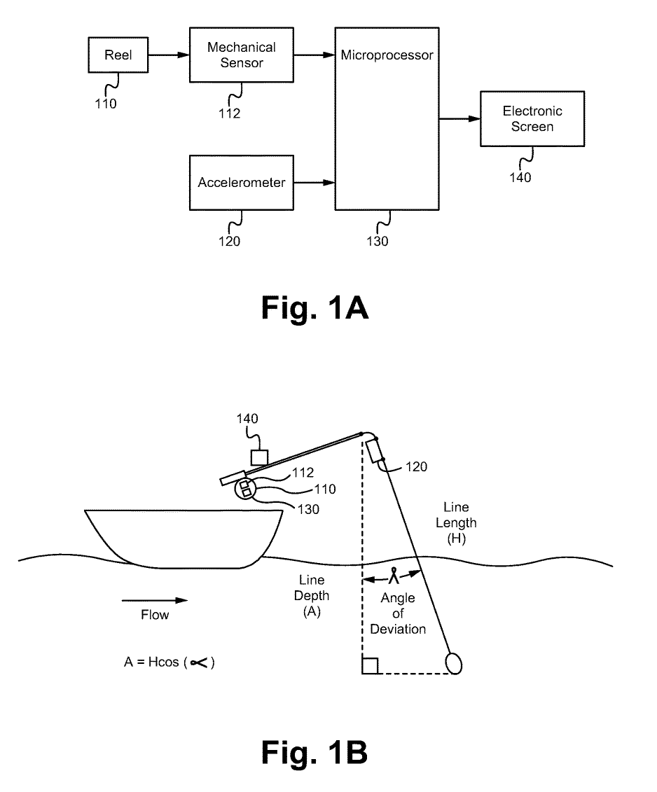

Referring now to FIGS. 1A and 1B, a system for determining depth of a line such as a fishing line submerged within a body of water is depicted therein. The system comprises a reel 110 for dispensing line, a mechanical sensor 112 for reading the amount of line dispensed, an accelerometer 120 coupled to the line at a point which the line becomes subject to gravity and for reading a deviation of the dispensed line from a vertical axis and a microprocessor 130 coupled to the mechanical sensor 112 and the accelerometer 120. The microprocessor 130 receives a signal from the mechanical sensor 112 and the accelerometer 120 and calculates a depth of the line based on the length of dispensed line and the deviation of the line from the vertical axis. In some embodiments, the accelerometer 120 is located at a point of suspension of the line, such as an end of a fishing pole or other point of suspension. In some embodiments, the line comprises a weight which applies tension to the line and causes the line to sink into the body of water. Additionally, although an accelerometer is shown in FIG. 1B, in some embodiments, an incline meter and/or a gyroscope is used to calculate a deviation of the dispensed line from the vertical axis.

In some embodiments, a length of the fishing line is measured as it is unwound from the reel 110. Because the line is weighted, it sinks within the water and applies tension to the line which keeps the line taught and/or straight. For a static body of water, line length is equal to the line depth. However, where the body of water is moving or has a current, relative to the point of suspension of the line, the line will be swept in the direction of movement. In this scenario, the line forms a hypotenuse of a right triangle and the depth of the line is equal to the cosine of the angle of displacement of the line from the vertical axis or a horizontal plane multiplied by the hypotenuse (fishing line length), or A=H*cos(a), such as shown in FIG. 1B.

The length of the dispensed line is able to be measured by the mechanical sensor 112 as it is unwound from the reel 110. In some embodiments, the reel 110 comprises a spool that rotates as the line is unreeled. Particularly, the spool is able to be part of the reel 110 itself or is separate or inline with the direction of the travel of the unwinding fishing line. In some embodiments, the mechanical sensor 112 is a hall effect sensor or other mechanical sensor configured to detect revolution of the spool or fractions of revolutions of the spool. The circumference of the spool is known such that measuring revolutions of the spool yields a linear distance of the dispensed line. The linear distance of the dispensed line is sent to the microprocessor 130. In some embodiments, an electronic pulse is produced by the mechanical sensor 110 as the spool rotate. These electronic pulses are sent to the microprocessor 130, which calculates the fishing line length.

In some embodiments, the fishing line passes through one or more eyelets or holes on each of two ends of the accelerometer 120. The accelerometer 120 is mounted and/or configured such that it reads deviations of the line from a vertical axis or a horizontal plane, such as used to measure tilt angle. The accelerometer 120 reads deviations of the line from a vertical axis or the horizontal plane at the point of suspension. The eyelets are mounted to the accelerometer 120 apart from each other and in line with the fishing line which passes through the holes in the eyelets. The accelerometer 120 and the eyelets are mounted such that when the fishing line is pulled tight in the horizontal plane and the line is “level” to gravity, the accelerometer reads zero gravity. When the line is submerged within the body of water and is swept by a motion of the water, accelerometer data reflects the angle formed by the line relative to gravity. The cosine of such angle when multiplied by the dispensed line length is equal to the line depth depth.

Particularly, as described above, the mechanical sensor 112 sends a signal to the microprocessor based on the amount of fishing line dispensed and the accelerometer 120 sends a signal to the microprocessor 130 based on the deviation of the line from the vertical axis or horizontal plane. The microprocessor 130 processes the signal from the mechanical sensor 112 and the accelerometer 120 and outputs a length of the submerged line. In some embodiments, the depth is output to an electronic screen 140 such as a LED or LCD screen. The microprocessor 130 is configured to output the code necessary to drive electronic screen 140.

In a dynamic scenario where the motion of the water increases and/or decreases, lateral force on the line changes and the angle of displacement of the line changes respectively. The accelerometer 120 is configured to calculate the change in angle and send a signal to the microprocessor 130 which is configured to calculate the change in line depth and/or the new line depth. In some embodiments, a battery or a solar cell is configured to power a circuit board which contains the microprocessor 130 and supporting components and also to provide power to the accelerometer 120.

In some instances, it is desirable to use an electronic fish finder for finding a desired size and species at a specific depth. Once the depth of a fish and/or a school of fish is determined, a user is able to add or subtract line to place bait at the depth corresponding depth as determined by the fish finder and the system such as described above. Additionally, if the user is trolling, the user is able to add or subtract line to place bait at the depth depending on the trolling speed.

In some embodiments, an electronic signal interfaces with an electronic spool or fishing reel that is able to be automatically wound or unwound to maintain a desired depth. Particularly, in some embodiments, the automatic reel is able to electronically interface with a fish finder and add or subtract fishing line to match the depth seen by the fish finder.

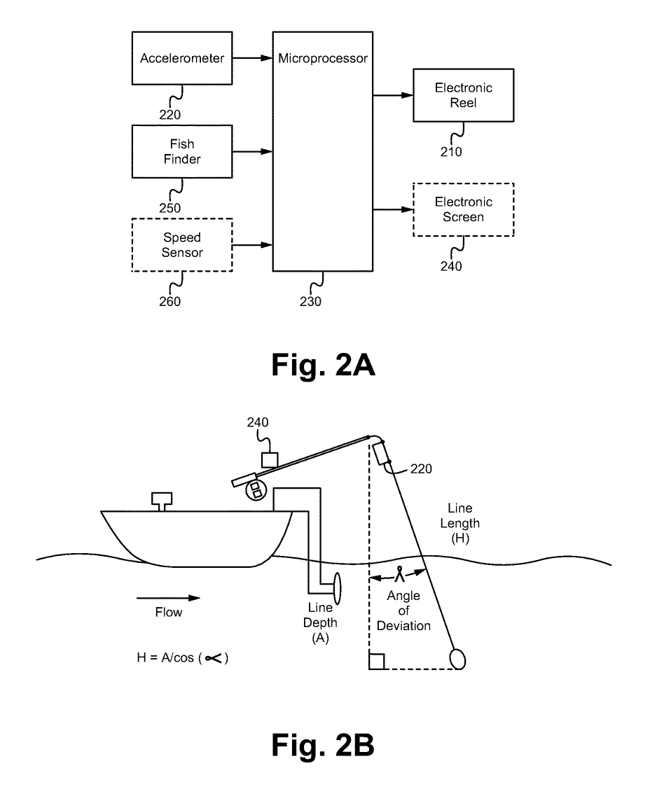

Referring now to FIGS. 2A and 2B, a system for dispensing an amount of line to a desired depth is depicted therein. As shown within FIG. 2A, a fish finder 250 for finding a depth of a desired species of fish, an accelerometer 220 for reading a deviation of dispensed line from a vertical axis and a microprocessor 230 coupled to the fish finder 250 and the accelerometer. The microprocessor 230 receives a signal from the fish finder 250 and the accelerometer 120 and calculates the amount of line that must be dispensed based on the depth of the desired fish. The microprocessor 230 then sends a signal to the electronic reel 210 to dispense the desired amount of line. Particularly, the microprocessor 230 is able to communicate with the electronic reel 210 to add or subtract line to match the depth as seen by the fish finder 250 and the angle of displacement of the line as calculated by the accelerometer 220. As described above, in some embodiments, the accelerometer 220 is located at a point of suspension of the line, such as an end of a fishing pole or other point of suspension. In some embodiments, the line comprises a weight which applies tension to the line and causes the line to sink into the body of water.

As described in relation to the system above, the accelerometer 220 is mounted and/or configured such that it reads deviations of the line from a vertical axis or a horizontal plane, such as used to measure tilt angle. The accelerometer 220 reads deviations of the line from a vertical axis or the horizontal plane at the point of suspension. For a static body of water, the line depth is equal to the dispensed line length. However, as described above, where the body of water is moving or has a current, relative to the point of suspension of the line, the line will be swept in the direction of movement. In this scenario, the line forms a hypotenuse of a right triangle and the desired dispensed line length (hypotenuse) is equal to the depth of the desired fish divided by the cosine of the angle of displacement, or H=A/cos(a) such as shown in FIG. 2B. In some embodiments, the depth of the line is outputted to a electronic screen 240 such as a LED or LCD screen.

In some embodiments, the length of the dispensed line is measured by a mechanical sensor as it is unwound from the reel 210, such as described above. In some embodiments, the reel comprises a spool that rotates as the line is unreeled. Particularly, the spool is able to be part of the reel 210 itself or is separate or inline with the direction of the travel of the unwinding fishing line. In some embodiments, the mechanical sensor is a hall effect sensor or other mechanical sensor configured to detect revolution of the spool or fractions of revolutions of the spool. The circumference of the spool is known such that measuring revolutions of the spool yields a linear distance of the dispensed line. The linear distance of the dispensed line is sent to the microprocessor 230. In some embodiments, an electronic pulse is produced by the mechanical sensor as the spool rotates. These electronic pulses are sent to the microprocessor 230, which calculates the fishing line length. The length of the dispensed fishing line is able to be adjusted to add or subtract line to match the depth as seen by the fish finder 250.

In further embodiments, such as shown within FIG. 2, a speed sensor 260 additionally sends a signal to the microprocessor 230 based on a speed of the boat. Line is correspondingly adjusted to add or subtract line to place bait at the desired depth depending on the speed.

In further embodiments, the system does not utilize data from an accelerometer because the line is and remains essentially vertical, even with a lateral flow of water. Such is the case when a large weight is attached to the end of the line, which causes a domination of gravitational force over the lateral force. In such a case, the microprocessor communicates directly with the electronic reel to wind and unwind the line to the desired depth. In further embodiments, the system does not use an accelerometer but receives data directly from the fish finder and stored the target depth. The microprocessor then communicates with the electronic reel to wind or unwind the line to the desired depth. In further embodiments, the system is configured to calculate fish size, depth, and fish species from raw data provided by the fish finder. In still further embodiments, the system originates the start, the stop, wind, unwind and tension signals to communicate with an electronic reel. In some embodiments, the system sounds an audible alarm as it reaches or nears the target depth. In some embodiments, the alarm is altered according to a size and/or a type of fish.

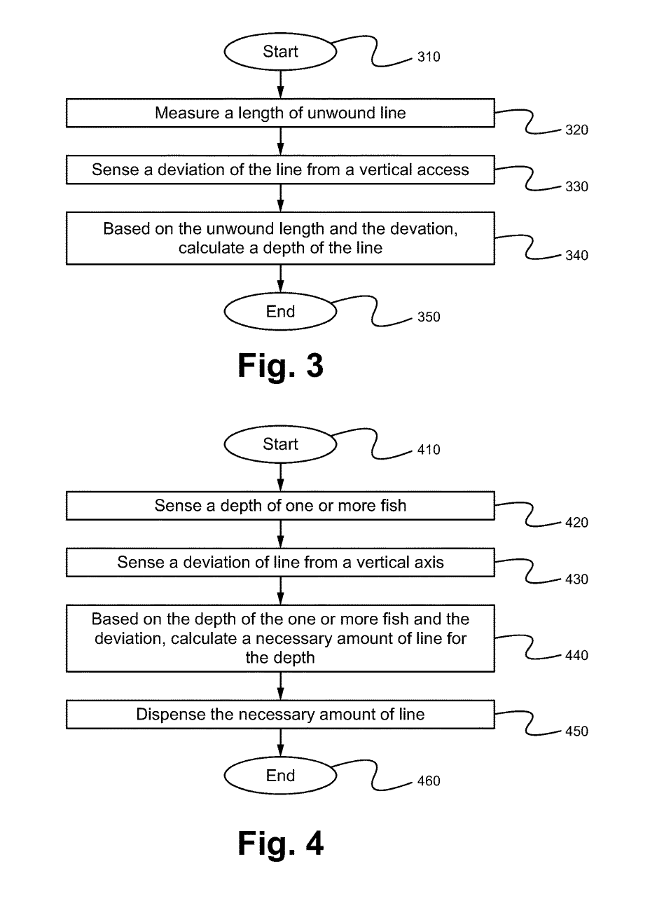

FIG. 3 illustrates a method of calculating a depth of submerged line. The method begins in the step 310. In the step 320, a length of unwound line is measured. In some embodiments, the line is measured by a mechanical sensor coupled to a reel. Then, in the step 330, a deviation from the line from a vertical axis is calculated. For example, in some embodiments, an accelerometer is coupled to the reel and the line and reads a deviation of the dispensed line from a vertical axis. In some embodiments, the accelerometer reads the deviation of the line at a point of suspension. Then, based on the length of the unwound or dispensed line, and the deviation of the line from the vertical axis or horizontal plane in the step 340 the depth of the line is calculated. In some embodiments the length of the dispensed line is outputted on an electronic screen. In the step 350 the method ends.

FIG. 4 illustrates a method of dispensing an amount of line to a desired depth. The method begins in the step 410. In the step 420, a depth of a desired species and/or size of fish is sensed. In some embodiments, the desired species and/or size of fish is sensed using a fish finder. Then, in the step 430, a deviation of the line from a vertical axis or a horizontal plane is sensed. In some embodiments, the accelerometer reads the deviation of the line at a point of suspension. Then, in the step 440 based upon the desired depth and a deviation of the line from the vertical axis or horizontal plane the necessary amount of line is calculated and in the step 450 the line is dispensed to the desired depth. In some embodiments the length of the dispensed line is output on an electronic screen. In the step 460 the method ends.

In operation, a depth of line submerged within a body of water is able to be calculated based on a length of the dispensed line and a deviation of the line from a vertical axis or a horizontal plane. Additionally, the line is able to dispensed to a desired depth based on the deviation from the vertical axis or horizontal plane and the desired depth. Particularly, the dispensed length of the line and the desired depth is able to be calculated in a moving body of water without expensive and more elaborate means. Accordingly, the invention as described herein has many advantages.

Of course, the present invention has additional uses that are not discussed in the embodiments above. The present invention has been described in terms of specific embodiments incorporating details to facilitate the understanding of the principles of construction and operation of the invention. As such, references herein to specific embodiments and details thereof are not intended to limit the scope of the claims appended hereto. It will be apparent that those skilled in the art that modifications can be made to the embodiments chosen for illustration without departing from the spirit and scope of the invention.

1. A system for determining a depth of a line submerged within a body of water comprising:
a. a reel for dispensing line;
b. a mechanical sensor coupled to the reel for reading the amount of dispensed line;
c. an accelerometer coupled to the line and configured for measuring a displacement of the line from a vertical axis; and
d. a microprocessor that receives a signal from the mechanical sensor and the accelerometer and calculates a depth of the line based on the dispensed line and the deviation of the line from the vertical axis.

2. The system of claim 1, wherein the accelerometer is located at a point of suspension of the line.

3. The system of claim 1, wherein the line comprises a weight that causes the line to sink within the body of water.

4. The system of claim 1, wherein the body of water is moving.

5. The system of claim 1, wherein the depth of the line is outputted to an electronic screen.

6. The system of claim 1, wherein the depth of the line is equal to the amount of dispensed line multiplied by the cosine of the angle of displacement.

7. A system for detecting an amount of line to dispense to a desired depth of a body of water, the system comprising:
a. a fish finder for finding one or more fish at a depth within the body of water;
b. an electronic reel for dispensing line;
c. an accelerometer coupled to the line and configured for measuring a displacement of the line from a vertical axis; and
d. a microprocessor that receives a signal from the fish finder and the accelerometer and calculates a necessary amount of line for the depth of the fish based on the depth of the one or more fish and the deviation of the line from the vertical axis.

8. The system of claim 7, wherein the microprocessor sends a signal to the electronic reel to dispense the necessary amount of line for the depth of the one or more fish.

9. The system of claim 7, wherein the accelerometer is located at a point of suspension of the line.

10. The system of claim 7, wherein the line comprises a weight that causes the line to sink within the body of water.

11. The system of claim 7, wherein the body of water is moving.

12. The system of claim 7, wherein the necessary amount of line for the depth of the one or more fish is outputted to an electronic screen.

13. The system of claim 7, wherein the necessary amount of line for the depth of the one or more fish is equal to the depth of the fish divided by the cosine of the angle of displacement.

14. The system of claim 7, wherein the microprocessor receives a signal from a speed sensor based on a trolling speed.

15. A method of calculating a depth of submerged line comprising:
a. measuring a length of unwound line;
b. sensing an angle of deviation of the unwound line from a vertical axis; and
c. based on the length of the unwound line and the deviation of the unwound line from the vertical axis calculating the depth of the line within a body of water.

16. The method of claim 15, wherein an accelerometer is used to calculate the deviation of the unwound line from the vertical axis.

17. The method of claim 15, wherein an incline meter is used to calculate the deviation of the unwound line from the vertical axis.

18. The method of claim 15, wherein a gyroscope is used to calculate the deviation of the unwound line from the vertical axis.

19. The method of claim 15, wherein the body of water is moving.

20. The method of claim 15, wherein the depth of the line is outputted to an electronic screen.

21. The method of claim 15, wherein the depth of the line is equal to the amount of dispensed line multiplied by the cosine of the angle of displacement.

22. A method of dispensing an amount of line to a desired depth comprising:
a. sensing a depth of one or more fish;
b. sensing a deviation of dispensed line from a vertical axis;
c. based on the depth of the one or more fish and the deviation of dispensed line from the vertical axis calculating a necessary amount of line for the depth of the fish; and
d. dispensing the necessary amount of line for the depth of the fish.

23. The method of claim 22, wherein the body of water is moving.

24. The method of claim 22, wherein the necessary amount of line for the depth of the one or more fish is outputted to an electronic screen.

25. The method of claim 22, wherein the necessary amount of line for the depth of the one or more fish is equal to the depth of the fish divided by the cosine of the angle of displacement.

26. A system for determining a depth of a line submerged within a body of water comprising:
a. a mechanical sensor coupled to a reel for reading an amount of dispensed line;
b. an accelerometer coupled to the line and configured for measuring a displacement of the line from a vertical axis; and
c. a microprocessor that receives a signal from the mechanical sensor and the accelerometer and calculates a depth of the line based on the dispensed line and the deviation of the line from the vertical axis.

27. A method of calculating a depth of submerged line comprising:
a. sensing an angle of deviation of an unwound line from a vertical axis; and
b. based on a length of the unwound line and the deviation of the unwound line from the vertical axis calculating the depth of the line within a body of water.
